(19) United States
(12) Patent Application Publication
(10) Pub. No.: US 2006/0251241 A1
(43) Pub. Date: Nov. 9, 2006

(54) DC power switching device

(76) Inventor: Jeong-baek Lee, Suwon-si (KR)

Correspondence Address: STANZIONE & KIM, LLP, 919 18TH STREET, N.W., SUITE 440, WASHINGTON, DC, 20006, US

(21) Appl. No.: 11/365,673

(22) Filed: Mar. 2, 2006

(30) Foreign Application Priority Data
May 3, 2005 (KR) 2005-37210

(51) Int. Cl. H04M 1/00

(52) U.S. Cl. 379/399.01

(57) ABSTRACT

A power switching device usable with an image forming apparatus having telephone functions includes a bridge diode connected to a telephone line, a power supply unit to form a loop with the bridge diode, and to supply a first DC power outside the power switching device, a photo coupler to close/open the loop, and a control unit to control the photo coupler. The power switching device is compact and inexpensive including a photo coupler.

### CROSS-REFERENCE TO RELATED APPLICATIONS

This application claims the benefit under 35 U.S.C. § 119 of Korean Patent Application No.2005-37210 filed on May 3, 2005 in the Korean Intellectual Property Office, the entire contents of which are hereby incorporated by reference.

### BACKGROUND OF THE INVENTION

1. Field of the Invention

The present general inventive concept relates to a DC power switching device, and in particular, relates to a device to turn on/off DC power which is supplied through a telephone line.

2. Description of the Related Art

An image forming apparatus provided with telephone functions, such as a facsimile device, is widely distributed and used. In such an image forming apparatus having the telephone functions, a method for receiving automatically fax data in an automatic receiving mode, and a method for receiving the fax data in a manual receiving mode in order to be able to use the other telephone functions and the facsimile functions are used as methods for receiving the fax data.

Operations of such a facsimile device which receives fax data in a common manual receiving mode will be explained in detail. First, the facsimile device detects a ring signal and rings. When a receiver detects the ringing, the receiver performs a hook-off operation by raising a handset. When the hook-off operation is detected in the facsimile device, a calling tone (CNG), which is output in an automatic transmission mode, is detected by a transmitting side, thereby transmitting the CNG to the receiver through the handset. Then, the receiver detects the CNG tone transmitted through the handset, manipulates a receiving key for setting the facsimile device in a receiving state and performs a hook-on (hang up) operation by putting down the handset. The facsimile device detects the hook-on operation and starts to receive the fax data.

FIG. 1 is a view schematically illustrating a facsimile device as one example of an image forming apparatus having such telephone functions as described above. Referring to FIG. 1, a control unit 10 controls general operations of the facsimile device. A memory 20 stores an execution program of the facsimile device as well as data which is generated during execution of the execution program. Further, the memory 20 stores various types of display data and voice guide message data. An operation panel 30 consists of a key input unit 30a and a display unit 30b. The key input unit 30a includes numeric keys for generating the telephone numbers, and various functional keys as well as a receiving key. Thus, the key input unit 30a generates related key data when an outside manipulation (user input) occurs and outputs the related key data to the control unit 10. The display unit 30b may be a liquid crystal display (LCD) device, and displays display data according to the control of the control unit 10.

A scanner 40 scans an original document, converts information from the scanned document into binary data, and outputs the binary data to the control unit 10. A printer 50 receives the binary data of the received document according to the control of the control unit 10, and prints the binary data on copy papers. A modem 60 modulates digital data to be transmitted as analog data, and demodulates received data to digital data.

A line interface unit (LIU) 70 interfaces the modem 60 and a telephone network to enable communication between the image forming apparatus and the telephone network. Specifically, a telephone circuit is embedded in the LIU 70. A voice processing unit 80 converts voice guide message data into a voice message and outputs the voice message through a speaker 90.

FIG. 2 is a view illustrating in detail a conventional LIU 70 of FIG. 1.

A Current Mode Logic Circuit (CML) 72 is connected to a telephone line, and is a relay for switching between the facsimile function and the telephone function according to a control of the control unit 10. That is, the relay enables switching between a hook-on mode (idle mode) and a hook-off mode.

A DC feeding unit 73 supplies first DC power, which is received through a bridge diode 71 according to on/off operations of the CML 72. A ring detection unit 74 and a hook-off detection unit 76 detect a CNG tone and a hook-off operation, respectively, and output corresponding data to the control unit 10.

A telephone circuit 75 having the handset 77 is further included in the LIU 70.

Operations of the LIU 70 will be described in detail. The CML 72 is connected to the ring detection unit 74 as long as the handset 77 is in a hook-on state. When a ring is detected by the ring detection unit 74, the receiver performs a hook-off operation by raising the handset 77. Then, the hook-off detection unit 76 detects the hook-off operation, and outputs hook-off information (ringing) to the control unit 10. Upon receiving the hook-off information, the control unit 10 controls the CML 72 to be switched in order to supply the first DC power to a system (e.g., the facsimile device) outside the LIU 70 via the DC feeding unit 73. Further, the control unit 10 reads voice guide message data from the memory 20 (see FIG. 1) and sends the voice guide message data to the voice processing unit 80. Then, the voice processing unit 80 converts the voice guide message data into a voice message, and outputs the voice message through the speaker 90. Here, the voice message is a message which guides by using a voice for switching the facsimile device to a receiving mode for receiving fax data. Users recognize that the fax data would be received, and manipulate the receiving key to the receiving mode according to the voice message. The control unit 10 receives the fax data, and controls the fax data to be stored in the memory 20, or to be printed through the printer 50 (see FIG. 1).

As described above, in the conventional facsimile device, a CML is used as a relay for switching between the hook-on mode and the hook-off mode.

Since the size of the is required to be small, and therefore the price is very expensive, the relay can not be employed in the image forming apparatus in which the telephone functions are embedded, or a telephone which is intended to remain compact as multi-media functions are being added.

### SUMMARY OF THE INVENTION

The present general inventive concept provides a switching device to switch between a hook-on mode and a hook-off mode, which uses a photo coupler that is compact and cheap and does not use a CML relay.

Additional aspects and advantages of the present general inventive concept will be set forth in part in the description which follows and, in part, will be obvious from the description, or may be learned by practice of the general inventive concept.

The foregoing and/or other aspects of the present general inventive concept are achieved by providing a power switching device usable with an image forming apparatus having telephone functions including a bridge diode connected to a telephone line, a power supply unit to form a loop along with said bridge diode, and to supply a first DC power outside the power switching device, a photo coupler to close/open the loop, and a control unit to control the photo coupler.

The power switching device may further comprise a hook-off detection unit to detect a hook-off signal of the telephone line, and if the hook-off signal is detected by the hook-off detection unit, the control unit controls the photo coupler to close the loop.

The power switching device may further comprise a ring detection unit to detect a ring signal of the telephone line, and if a predetermined number of ring signals are detected by the ring detection unit, the control unit controls the photo coupler to automatically close the loop.

The photo coupler may include a photo transistor disposed in the loop between the bridge diode and the power supply unit, and a light-emitting diode (LED) connected to the control unit so that the phot transistor closes the loop when the light emitting device emits light. Therefore, the photo transistor is turned on/off according to the on/off operations of the LED.

The foregoing and/or other aspects of the present general inventive concept are also achieved by providing a power switching device of a telephone including a photo coupler to turn on/off supplying DC power from a telephone line to the telephone.

The power switching device may further comprise a bridge diode connected to the telephone line, and a power supply unit to form a loop with the bridge diode, and to output a first DC power, wherein the photo coupler controls the loop to be open or closed.

The power switching device may further comprise a hook-off detection unit to detect the hook-off signal of the telephone line, wherein if the hook-off signal is detected by the hook-off detection unit, the control unit controls the photo coupler to be turned on to allow the first DC power to be supplied by the power supply unit to the telephone. The photo coupler may comprise a photo transistor disposed between the bridge diode and the power supply unit, and a light-emitting diode (LED) connected to the control unit.

The foregoing and/or other aspects of the present general inventive concept are also achieved by providing a line interface unit to selectively output DC power from a telephone line, the line interface unit including a photo-coupler to close/open a connection between the telephone line and an output outlet, and a controller connected to the telephone line to control the photo-coupler to selectively close the connection to allow DC power from the telephone line to be provided outside of the line interface unit through the output outlet.

The foregoing and/or other aspects of the present general inventive concept are also achieved by providing an image forming apparatus having telephone functions, including a line interface unit having a photo-coupler to close/open a connection between the telephone line and an output outlet, and a controller connected to the telephone line to control the photo-coupler to selectively close the connection to allow DC power from the telephone line to be provided outside of the line interface unit through the output outlet.

The foregoing and/or other aspects of the present general inventive concept are also achieved by providing a telephone line switching device to manage a telephone and an apparatus connected in parallel to a telephone line, the telephone line switching device including a photo-coupler to close/open a connection between the telephone line and the apparatus, and a controller connected to the telephone line to control the photo-coupler to selectively close the connection, functioning in a first mode when the controller controls the photo-coupler to automatically the connection in a first mode, and the controller controls the photo-coupler to close the connection when predetermined conditions are satisfied in a second mode.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a view schematically illustrating a facsimile device.

FIG. 2 is a block diagram illustrating a conventional line interface unit usable with the facsimile device of FIG. 1.

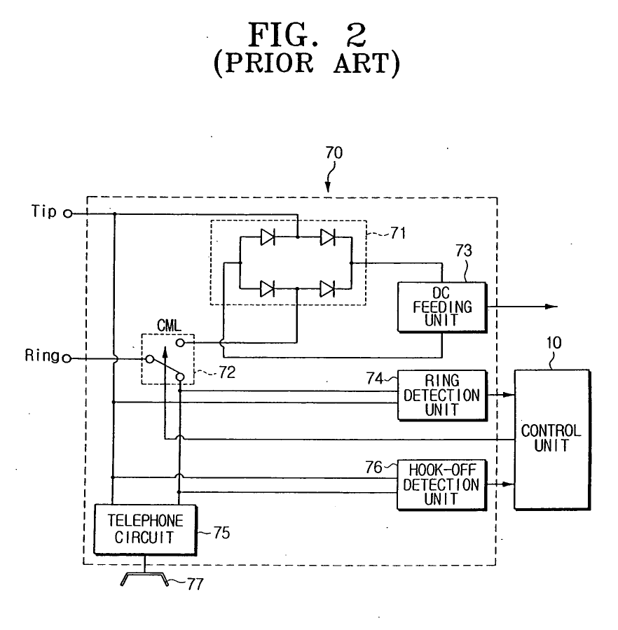

FIG. 3 is a view illustrating a line interface unit according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

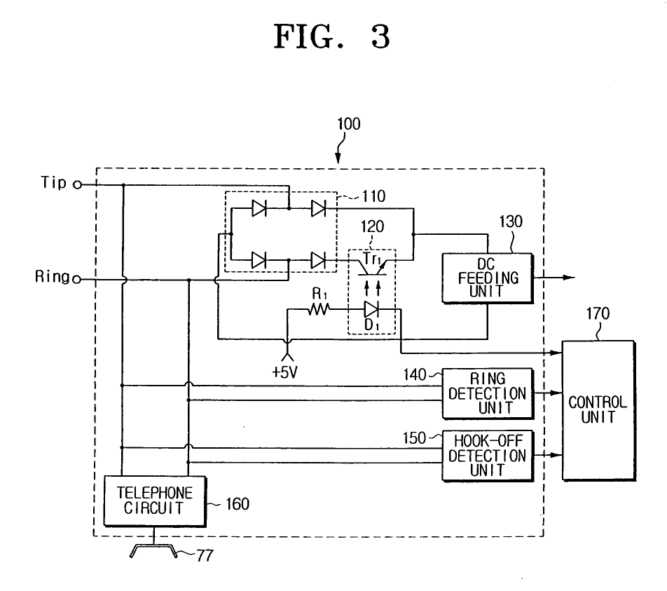

FIG. 3 is a view illustrating a line interface unit (LIU) 100 according to an embodiment of the present general inventive concept. A ring detection unit 140 and a hook-off detection unit 150 detect a CNG tone and a hook-off operation, respectively, and output corresponding data to the control unit 10.

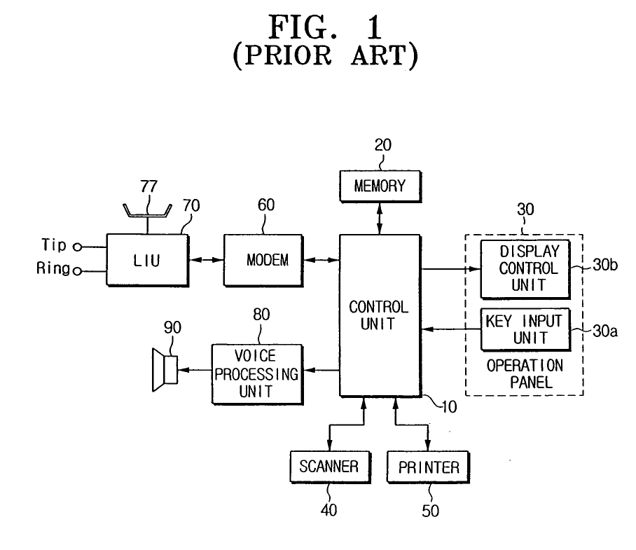

A DC feeding unit 130 is connected to a bridge diode 110 serially, and forms a closed loop to supply a first DC power received from a telephone line to a system outside the LIU 100 (e.g., a facsimile device as the one illustrated in FIG. 1).

The bridge diode 110 is arranged to rectify the first DC power which is supplied from the telephone line. Since the telephone line uses a DC power, terminals of the telephone line are classified into a tip line having a positive polarity (Tip), and a ring line having a negative polarity (Ring). The bridge diode 110 is used to rectify the DC power received from the telephone line by using a simple structure regardless of the polarity.

Because the photo coupler 120 is formed between the DC feeding unit 130 and the bridge diode 110, a closed loop including each of these elements is controlled to be in an on or off state by the photo coupler 120. To be more specific, a collector and an emitter of a photo transistor Tr1 (of the photo coupler 120) are connected serially in the closed loop including the DC feeding unit 130 and the bridge diode 110, and the loop is closed/open depending on turning on/off an LED (D1) of the photo coupler 120 according to a control of the control unit 170. In other words, when the control unit 170 controls the LED D1 to be activated, the photo transistor Tr1 closes the loop, and then the DC feeding unit 130 receives the DC power from the phone line through the bridge diode 110.

Since the photo coupler 120 performs only on/off control of the loop formed between the DC feeding unit 130 and the bridge diode 110, the photo coupler 120 may be arranged at any positions in the loop. However, in the present embodiment, it is assumed that a power is turned on/off between the DC feeding unit 130 and the bridge diode 110. That is, since a voltage difference of approximately 30-50V (generally, 48V) is generated between the telephone lines (Tip and Ring), in the present embodiment, the photo coupler 120 controls a power line which passes through the bridge diode 110, that is, controls the power line of the rectified state to be in an on or off state rather than the power line which is directly connected to the telephone line.

The LED D1 is a diode which emits light when a current flows therethrough in a forward direction. In the present embodiment, an anode of the LED D1 is connected to a high power source (+5V) via a resistor (R₁) to protect the LED D1 in case an overcurrent occurs. A cathode of the LED is connected to the control unit 170. That is, if the cathode is set to a low voltage, the +5V power source can enable the LED to emit light.

The control unit 170 drives the LED D1 when the hook-off operation is detected by the hook-off detection unit 150, and thereby the photo coupler 120 is turned on. Consequently, the DC feeding supply unit 130 controls the DC power to be supplied outside the LIU 100. Further, when the facsimile is set to an automatic receiving mode, after the ring signal is detected in the ring detection unit 140, if a predetermined number of times that the hook-off operation is not detected in the hook-off detection unit 150, the photo coupler 120 is automatically turned on. Therefore, the DC feeding unit 130 controls supplying the first DC power outside the LIU 100.

The LIU 100 includes a general telephone circuit 160 connected to the handset 77.

If a ring signal is detected by the ring detection unit 140 through the telephone line (Tip, Ring), the control unit 170 determines whether the facsimile device is in an automatic receiving mode or not. Then, if the control unit 170 determines that the facsimile device is in the automatic receiving mode, the control unit 170 waits until the ring signal is detected for the predetermined number of times. If the control unit 170 determines that the facsimile device is not in the automatic receiving mode, the control unit 170 waits until the hook-off operation is detected by the hook-off detection unit 150.

As described above, if the predetermined number of ring signals are detected, or if the hook-off operation is detected by the hook-off detection unit 150, the control unit 170 provides a “Low” voltage to the LED(D₁) in order to drive the photo coupler 120.

When the LED (D₁) connected between the ‘Low’ voltage and the +5V emits light, the photo transistor (Tr₁) is turned on, and connects (e.g.,closes the loop) the DC feeding unit 130 and the bridge diode 110. Then, the first DC power is supplied from the DC feeding unit 130 to a system outside the LIU 100. For illustrative purposes, the system outside the LIU is considered to be the facsimile device of FIG. 1. However, the present general inventive concept is not intended to be limited to connecting the facsimile device, and other image forming apparatuses having telephone functions or other apparatuses receiving power from a telephone line can be applied. Further, the control unit 10 reads a voice guide message data from the memory 20 (see FIG. 1) and transmits the voice guide message data to the voice processing unit 80, which converts the voice guide message data into a voice message and outputs the voice message through the speaker 90. The receiver (or user) recognizes that the fax data can be received, and manipulates the receiving key to set the fax device in the receiving state according to the voice message. The control unit 10 receives the fax data after manipulation of the receiving key, and controls the fax data to be temporarily stored in the memory 20, or to be printed through the printer 50.

As described above, a facsimile device having telephone functions may be connected to a telephone line by a line interface unit 100 of the present embodiment, but in another embodiment of the present general inventive concept, a facsimile device can be used with a general wire/wireless telephone since the present general inventive concept is directed to a device to control power supplied from the telephone line by a simple structure.

As described above, the line interface unit 100 that acts as a DC power switching device according to embodiments of the present general inventive concept is cost effective, and the size of the line interface unit is reduced by forming a compact and inexpensive photo coupler and not using a CML relay.

Although a few embodiments of the present general inventive concept have been shown and described, it will be understood and appreciated by those skilled in the art that the present general inventive concept should not be limited to the described embodiments, and various changes and modifications can be made within the spirit and scope of the present general inventive concept, the scope of which is defined by the appended claims and their equivalents.

What is claimed is:

1. A power switching device usable with an image forming apparatus having telephone functions, the power switching device comprising:
a bridge diode connected to a telephone line;
a power supply unit to form a loop with the bridge diode, and to supply a first DC power to the image forming apparatus;
a photo coupler to close and open the loop; and
a control unit to control operation of the photo coupler.

2. The power switching device of the claim 1, further comprising:
a hook-off detection unit to detect a hook-off signal of the telephone line, wherein if the hook-off signal is detected by the hook-off detection unit, the control unit controls the photo coupler to close the loop.

3. The power switching device of the claim 2, further comprising:
a ring detection unit to detect a ring signal of the telephone line, wherein if a predetermined number of ring signals are detected by the ring detection unit, the control unit controls the photo coupler to automatically close the loop.

4. The power switching device of the claim 1, wherein the photo coupler comprises:
a photo transistor connected between the bridge diode and the power supply unit; and
a light-emitting diode (LED) connected to the control unit so that the photo transistor closes the loop when the light-emitting diode emits light.

5. A power switching device of a telephone, comprising:
a photo coupler to turn on/off supplying of DC power from a telephone line to the telephone.

6. The power switching device of the claim 5, further comprising:
a bridge diode connected to the telephone line; and
a power supply unit to form a loop with the bridge diode and to output the DC power, wherein the photo coupler controls opening and closing of a loop connecting the bridge diode and the power supply unit.

7. The power switching device of the claim 6, further comprising:
a hook-off detection unit to detect a hook-off signal of the telephone line, wherein if the hook-off signal is detected by the hook-off detection unit, the control unit controls the photo coupler to be turned on to allow the DC power to be supplied by the power supply unit to the telephone.

8. The power switching device of the claim 6, wherein the photo coupler comprises:
a photo transistor disposed between the bridge diode and the power supply unit; and
a light-emitting diode (LED) connected to the control unit such that when the control unit controls the light-emitting diode to emit light, the photo transistor connects the bridge diode and the power supply unit.

9. A line interface unit to selectively output DC power from a telephone line, the line interface unit comprising:
a photo-coupler to close/open a connection between the telephone line and an output; and
a controller connected to the telephone line to control the photo-coupler to selectively close the connection to allow DC power from the telephone line to be provided outside of the line interface unit through the output.

10. The line interface unit of the claim 9, wherein the photo-coupler comprises:
a photo-transistor that closes the connection between the telephone line and the output when receiving light; and
an LED connected between the control unit and a power source to emit light toward the photo-transistor.

11. The line interface unit of the claim 9, further comprising:
a rectifier connected between the telephone line and the output to provide a DC power having the same polarity regardless of the DC power input from the telephone line.

12. The line interface unit of the claim 11, wherein the rectifier is connected between the telephone line and the photo-coupler.

13. The line interface unit of the claim 11, wherein the rectifier comprises a bridge diode circuit.

14. The line interface unit of the claim 9, wherein the controller controls the photo-coupler to automatically close the connection in a first mode, and the controller controls the photo-coupler to close the connection when predetermined conditions are satisfied in a second mode.

15. The line interface unit of the claim 14, wherein the predetermined conditions comprise not using a telephone circuit connected to the phone line.

16. The line interface unit of the claim 15, further comprising:
a hook-off detection unit connected between the telephone line and the control unit to detect when the telephone circuit is not used and send a message to the control unit.

17. The line interface unit of the claim 14, wherein the predetermined conditions comprise setting a receiving mode.

18. The line interface unit of the claim 14, wherein the predetermined conditions comprise receiving a predetermined number of ring signals through the telephone line.

19. A telephone line switching device to manage a telephone and an apparatus connected in parallel to a telephone line, the telephone line switching device comprising:
a photo-coupler to close/open a connection between the telephone line and the apparatus; and
a controller connected to the telephone line to control the photo-coupler to selectively close the connection, the controller operating in a first mode when the controller controls the photo-coupler to automatically the connection in a first mode, and in a second mode to control the photo-coupler to close the connection when predetermined conditions are satisfied in a second mode.

20. The telephone line switching device of the claim 19, wherein the predetermined conditions are one of not using the telephone, receiving a signal to connect the apparatus, and receiving a predetermined number of ring signals through the telephone line.
